(19) United States
(12) Patent Application Publication
(10) Pub. No.: US 2017/0129056 A1
(43) Pub. Date: May 11, 2017

(54) FLUX-CORED WIRE FOR CARBON DIOXIDE GAS SHIELDED ARC WELDING

(71) Applicant: NIPPON STEEL & SUMIKIN WELDING CO., LTD., Tokyo (JP)

(72) Inventors: Rikiya TAKAYAMA, Tokyo (JP); Kiyohito SASAKI, Tokyo (JP); Yasuhito TOTSUKA, Tokyo (JP); Masaaki TORIYABE, Tokyo (JP)

(73) Assignee: NIPPON STEEL & SUMIKIN WELDING CO., LTD., Tokyo (JP)

(21) Appl. No.: 15/299,065

(22) Filed: Oct. 20, 2016

(30) Foreign Application Priority Data
Nov. 11, 2015 (JP) 2015-220945

(51) Int. Cl. B23K 35/02; B23K 35/36; B23K 35/368; C22C 38/16; C22C 38/00; C22C 38/08; C22C 38/06; C22C 38/04; C22C 38/02; B23K 35/30; C22C 38/14

(52) U.S. Cl. CPC B23K 35/0266; B23K 35/3073; B23K 35/361; B23K 35/3608; B23K 35/3607; B23K 35/368; C22C 38/16; C22C 38/14; C22C 38/08; C22C 38/06; C22C 38/04; C22C 38/02; C22C 38/002

(57) ABSTRACT

A flux-cored wire for carbon dioxide gas shielded arc welding includes, in terms of % by mass with respect to a total mass of the wire, 0.03 to 0.08% of C, 0.2 to 0.6% of Si, 1.2 to 2.8% of Mn, 0.01 to 0.5% of Cu, 0.2 to 0.7% of Ni, 0.1 to 0.6% of Ti, 0.005 to 0.020% of B, 0.05% or less of Al, 4.0 to 8.0% in terms of TiO₂, 0.1 to 0.6% of in terms of SiO₂, 0.02 to 0.3% in terms of Al₂O₃, 0.1 to 0.8% of Mg, 0.05 to 0.3% in terms of F, 0.05 to 0.3% in terms of Na and K in a fluorine compound, 0.05 to 0.2% of Na₂O and K₂O, and 0.2% or less in terms of ZrO₂.

### BACKGROUND

Technical Field

The present invention relates to a flux-cored wire for carbon dioxide gas shielded arc welding providing excellent welding weldability in all-position welding, particularly in vertical position when a steel structure using soft steel, high tension steel in a class of 490 MPa, low temperature steel, or the like is manufactured, and capable of obtaining a weld metal having an excellent characteristic such as excellent low-temperature cracking resistance, low-temperature toughness at −40° C., or fracture toughness (hereinafter, referred to as CTOD).

Related Art

As a flux-cored wire used for gas shielded arc welding using steel as a material to be welded, a rutile type flux-cored wire or a basic flux-cored wire is known. Welding using the basic flux-cored wire can reduce the amount of oxygen in a weld metal, and therefore the weld metal has excellent low-temperature toughness and CTOD characteristics. However, welding using the basic flux-cored wire has poorer welding weldability in all-position welding than welding using the rutile type flux-cored wire, and therefore is not often used generally.

On the other hand, carbon dioxide gas shielded arc welding using the rutile type flux-cored wire provides an extremely excellent welding efficiency and welding weldability in all-position welding, and therefore is applied in a wide range of fields such as shipbuilding, bridges, oceanic structures, and steel frames.

However, the rutile type flux-cored wire is obtained by filling a flux mainly including a metal oxide such as TiO₂ into a steel outer skin, and therefore a weld metal has a large amount of oxygen and does not easily obtain low-temperature toughness. Particularly when a CO₂ gas is used as a shielding gas, it is more difficult to secure toughness of the weld metal than a case where a mixed gas of Ar and CO₂ is used. In addition, the amount of diffusion hydrogen is larger than that in a solid wire due to moisture included in a raw material of the flux or moisture absorption while the wire is stored. Therefore, there is a risk of low-temperature cracking of a weld metal. It is necessary to perform preheating at about 100° C. when a thick steel plate is welded. This reduces a welding efficiency.

Various developments have been performed for a flux-cored wire for carbon dioxide gas welding for soft steel, high tension steel in a class of 490 MPa, and low temperature steel. For example, JP 2009-61474 A discloses a technology of adding an alloy component such as Ti which changes into a slag component during welding in order to obtain a weld metal having excellent low-temperature toughness by reducing the amount of oxygen in the weld metal while the amount of slag which prevents dripping of a molten metal (hereinafter, referred to as metal dripping) in vertical upward welding is maintained by adding the alloy component which changes into the slag component during welding.

However, the technology described in JP 2009-61474 A does not examine an effect of Na or K in a fluorine compound at all, and does not consider reduction of oxygen in a weld metal, improvement of low-temperature toughness of the weld metal, or improvement of a CTOD value thereof. In addition, an arc state is unstable, the amount of spatter occurring is large, and low-temperature cracking resistance is not considered although high-temperature cracking resistance is secured.

JP 2005-319508 A discloses a technology of a flux-cored wire for carbon dioxide gas welding providing excellent welding weldability in vertical posture and excellent low-temperature toughness about at −20° C. However, the technology disclosed in JP 2005-319508 A does not examine low-temperature toughness about up to −40° C. or a CTOD about at −10° C., and has such a problem that required low-temperature toughness or a required CTOD value cannot be obtained.

### SUMMARY

Therefore, the present invention has been achieved in view of the above-described problems. An object thereof is to provide a flux-cored wire for carbon dioxide gas shielded arc welding providing excellent welding weldability in all-position welding, particularly in vertical position when steel used for a steel structure or the like is welded, and capable of obtaining a weld metal having an excellent low-temperature cracking resistance, particularly excellent low-temperature toughness at −40° C. and excellent CTOD characteristics at −10° C.

The present inventors have variously studied a rutile type flux-cored wire for gas shielded arc welding using a carbon dioxide gas as a shielding gas in order to obtain a weld metal having excellent welding weldability (for example, metal dripping of a molten metal does not occur in all-position welding, particularly in vertical upward welding, an arc is stable, and the amount of spatter occurring is small), and having excellent low-temperature toughness at −40° C., an excellent CTOD value at −10° C., and excellent low-temperature cracking resistance.

As a result, the present inventors have found that it is possible to obtain a weld metal having excellent welding weldability in all-position and having excellent low-temperature toughness and CTOD value by forming the wire of a metal oxide mainly containing TiO₂, a slag component including a fluorine compound containing Na and K, an optimum alloy component, and a chemical component containing a deoxidizer. In addition, the present inventors have found that it is possible to improve low-temperature cracking resistance also in a weld metal having high strength by eliminating a seam in a steel outer skin.

That is, an abstract of the present invention is characterized by a flux-cored wire for carbon dioxide gas shielded arc welding obtained by filling a flux into a steel outer skin, including, in terms of % by mass with respect to a total mass of the wire, as a total in the steel outer skin and the flux, 0.03 to 0.08% of C, 0.2 to 0.6% of Si, 1.2 to 2.8% of Mn, 0.01 to 0.5% of Cu, 0.2 to 0.7% of Ni, 0.1 to 0.6% of Ti, 0.005 to 0.020% of B, and 0.05% or less of Al, and further including, in terms of % by mass with respect to the total mass of the wire, in the flux, 4.0 to 8.0% of a Ti oxide in terms of TiO₂ in total, 0.1 to 0.6% of a Si oxide in terms of SiO₂ in total, 0.02 to 0.3% of an Al oxide in terms of Al₂O₃ in total, 0.1 to 0.8% of Mg, 0.05 to 0.3% of a fluorine compound in terms of F in total, 0.05 to 0.3% of one kind or two kinds of Na and K in the fluorine compound in terms of Na and K in total, 0.05 to 0.2% of one kind or two kinds of Na₂O and K₂O in total, and 0.2% or less of a Zr oxide in terms of ZrO₂ in total, the balance being Fe in the steel outer skin, iron powder, a Fe component of iron alloy powder, and inevitable impurities.

In addition, the abstract of the present invention is further characterized by eliminating a seam in the molded steel outer skin by welding a joint of the steel outer skin.

According to the flux-cored wire for carbon dioxide gas shielded arc welding of the present invention, welding weldability is excellent, for example, in all-position welding, particularly in vertical upward welding, metal dripping does not occur, an arc is stable, and the amount of spatter occurring is small. In addition, a welding efficiency and a quality of a weld can be improved, for example, a weld metal having excellent low-temperature toughness at −40° C., an excellent CTOD value at −10° C., and excellent low-temperature cracking resistance can be obtained.

### BRIEF DESCRIPTION OF DRAWING

FIG. 1 illustrates a groove shape in a joint test used in Examples of the present invention.

### DETAILED DESCRIPTION

Hereinafter, compositions of components of a flux-cored wire for carbon dioxide gas shielded arc welding according to an embodiment of the present invention and a reason for limiting the compositions of components thereof will be described. The content of each component will be represented by % by mass with respect to a total mass of the flux-cored wire. The % by mass will be represented simply by %.

[C: 0.03 to 0.08% as a Total in Steel Outer Skin and Flux]

C improves strength of a weld metal. However, when a content of C is less than 0.03%, the strength of the weld metal is reduced. On the other, when the content of C is more than 0.08%, C remains in the weld metal excessively, and therefore the strength of the weld metal is too high, and low-temperature toughness thereof is reduced. Therefore, the content of C is set to be from 0.03 to 0.08% as a total in the steel outer skin and the flux. C can be added from metal powder, alloy powder, or the like in the flux in addition to a component included in the steel outer skin.

[Si: 0.2 to 0.6% as a Total in Steel Outer Skin and Flux]

Si partly becomes weld slag during welding, and thereby improves an appearance of a weld bead or a bead shape and contributes to improving welding weldability. However, when the content of Si is less than 0.2%, the bead appearance or the bead shape cannot be improved sufficiently. On the other, when the content of Si is more than 0.6%, Si remains in a weld metal excessively, and therefore low-temperature toughness of the weld metal is reduced. Therefore, the content of Si is set to be from 0.2 to 0.6% as a total in the steel outer skin and the flux. Si can be added from metal Si or alloy powder such as Fe—Si or Fe—Si—Mn in the flux in addition to a component included in the steel outer skin.

[Mn: 1.2 to 2.8% as a Total in Steel Outer Skin and Flux]

Mn remains in a weld metal, and thereby increases strength of the weld metal, low-temperature toughness thereof, and a CTOD value thereof. However, when a content of Mn is less than 1.2%, the strength of the weld metal, the low-temperature toughness thereof, and the CTOD value thereof are reduced. On the other hand, when the content of Mn is more than 2.8%, Mn remains in the weld metal excessively, therefore the strength of the weld metal becomes high, and low-temperature toughness of the weld metal and a CTOD value thereof are reduced. Therefore, the content of Mn is set to be from 1.2 to 2.8% as a total in the steel outer skin and the flux. Mn can be added from metal Mn or alloy powder such as Fe—Mn or Fe—Si—Mn in the flux in addition to a component included in the steel outer skin.

[Cu: 0.01 to 0.5% as a Total in Steel Outer Skin and Flux]

Cu makes a structure of a weld metal fine and increases low-temperature toughness of the weld metal and strength thereof. However, when a content of Cu is less than 0.01%, the strength of the weld metal and the low-temperature toughness thereof are reduced. On the other, when the content of Cu is more than 0.5%, the strength of the weld metal becomes too high, and the low-temperature toughness thereof is reduced. Therefore, the content of Cu is set to be from 0.01 to 0.5% as a total in the steel outer skin and the flux. Cu can be added from metal Cu or alloy powder such as Cu—Zr or Fe—Si—Cu in the flux in addition to a Cu plating component formed on a surface of the steel outer skin.

[Ni: 0.2 to 0.7% as a Total in Steel Outer Skin and Flux]

Ni improves low-temperature toughness of a weld metal and a CTOD value thereof. However, when a content of Ni is less than 0.2%, excellent low-temperature toughness of the weld metal or an excellent CTOD value thereof cannot be obtained. On the other, when the content of Ni is more than 0.7%, strength of the weld metal becomes too high. Therefore, the content of Ni is set to be from 0.2 to 0.7% as a total in the steel outer skin and the flux. Ni can be added from metal Ni or alloy powder such as Fe—Ni in the flux in addition to a component included in the steel outer skin.

[Ti: 0.1 to 0.6% as a Total in Steel Outer Skin and Flux]

Ti makes a structure of a weld metal fine and improves low-temperature toughness thereof and a CTOD value thereof. However, when the content of Ti is less than 0.1%, the low-temperature toughness of the weld metal and the CTOD value thereof are reduced. On the other, when the content of Ti is more than 0.6%, an upper bainite structure hindering toughness is occurred, and the low-temperature toughness of the weld metal and the CTOD value thereof are reduced. Therefore, the content of Ti is set to be from 0.1 to 0.6% as a total in the steel outer skin and the flux. Ti can be added from metal Ti or alloy powder such as Fe—Ti in the flux in addition to a component included in the steel outer skin.

[B: 0.005 to 0.020% as a Total in Steel Outer Skin and Flux]

A small amount of B added makes a microstructure of a weld metal fine and improves low-temperature toughness of the weld metal and a CTOD value thereof. However, when the content of B is less than 0.005%, the low-temperature toughness of the weld metal and the CTOD value thereof are reduced. On the other, when the content of B is more than 0.020%, the low-temperature toughness of the weld metal and the CTOD value thereof are reduced, and high-temperature cracking is easily occurred in the weld metal. Therefore, the content of B is set to be from 0.005 to 0.020% as a total in the steel outer skin and the flux. B can be added from metal B or alloy powder such as Fe—B, Fe—Mn—B, or Mn—B in the flux in addition to a component included in the steel outer skin.

[Al: 0.05% or Less as a Total in Steel Outer Skin and Flux]

Al remains in a weld metal as an Al oxide during welding to reduce low-temperature toughness of the weld metal. Therefore, the content of Al is set to be 0.05% or less as a total in the steel outer skin and the flux. Al is not an essential element but the content thereof may be 0%.

[Total Content of Ti Oxide in Terms of TiO₂ in Flux: 4.0 to 8.0%]

A Ti oxide contributes to stabilizing an arc during welding, improves a bead shape, and contributes to improving welding weldability. In addition, in vertical upward welding, the Ti oxide adjusts viscosity of a melted slag or a melting point thereof by being included in a weld slag as a Ti oxide, and prevents metal dripping. However, when a total content of the Ti oxide in terms of TiO₂ is less than 4.0%, the arc is unstable, the amount of spatter occurring is large, and a bead appearance and a bead shape are poor. In addition, in vertical upward welding, a metal drips easily. On the other, when the total content of the Ti oxide in terms of TiO₂ is more than 8.0%, the arc is stable and the amount of spatter occurring is small. However, the Ti oxide remains excessively in the weld metal, and low-temperature toughness is thereby reduced. Therefore, the total content of the Ti oxide in terms of TiO₂ in the flux is set to be from 4.0 to 8.0%. The Ti oxide is added from rutile, titanium oxide, titanium slag, ilmenite, or the like in the flux.

[Total Content of Si Oxide in Terms of SiO₂ in Flux: 0.1 to 0.6%]

A Si oxide adjusts viscosity of a melted slag or a melting point thereof to improve a slag encapsulation. However, when a total content of the Si oxide in terms of SiO₂ is less than 0.1%, the slag encapsulation is deteriorated and a bead appearance is poor. On the other, when the total content of the Si oxide in terms of SiO₂ is more than 0.6%, a basicity of the melted slag is reduced, and the amount of oxygen in the weld metal is thereby increased, and low-temperature toughness thereof is reduced. Therefore, the total content of the Si oxide in terms of SiO₂ in the flux is set to be from 0.1 to 0.6%. The Si oxide can be added from silica sand, zircon sand, sodium silicate, or the like in the flux.

[Total Content of Al Oxide in Terms of Al₂O₃ in Flux: 0.02 to 0.3%]

An Al oxide adjusts viscosity of a weld slag or a melting point thereof during welding to prevent metal dripping particularly in vertical upward welding. However, when a total content of the Al oxide in terms of Al₂O₃ is less than 0.02%, metal dripping easily occurs in vertical upward welding. On the other, when the total content of the Al oxide in terms of Al₂O₃ is more than 0.3%, the Al oxide remains excessively in the weld metal, and low-temperature toughness thereof is thereby reduced. Therefore, the total content of the Al oxide in terms of Al₂O₃ in the flux is set to be from 0.02 to 0.3%. The Al oxide can be added from alumina or the like in the flux.

[Mg in Flux: 0.1 to 0.8%]

Mg acts as a strong deoxidizer, and thereby reduces oxygen in a weld metal to increase low-temperature toughness of the weld metal. However, when the content of Mg is less than 0.1%, the low-temperature toughness of the weld metal and a CTOD value thereof are reduced. On the other, when the content of Mg is more than 0.8%, Mg reacts vigorously with oxygen in an arc during welding, the arc is unstable, and the amount of spatter occurring is large. Therefore, the content of Mg in the flux is set to be from 0.1 to 0.8%. Mg can be added from metal Mg or alloy powder such as Al—Mg in the flux.

[Total Content of Fluorine Compound in Terms of F in Flux: 0.05 to 0.3%]

A fluorine compound stabilizes an arc. However, when a total content of the fluorine compound in terms of F is less than 0.05%, the arc is unstable. On the other, when the total content of the fluorine compound in terms of F is more than 0.3%, the arc is unstable, and the amount of spatter occurring is large. In addition, metal dripping easily occurs in vertical upward welding. Therefore, the total content of the fluorine compound in terms of F in the flux is set to be from 0.05 to 0.3%. The fluorine compound can be added from CaF₂, NaF, LiF, MgF₂, K₂SiF₆, Na₃AlF₆, AlF₃, or the like. The content in terms of F is a total content of F included therein.

[Total Content of One Kind or Two Kinds of Na and K in Terms of Na and K in Fluorine Compound in Flux: 0.05 to 0.3%]

Na and K in a fluorine compound further reduce oxygen in a weld metal (such a reduction of oxygen cannot be performed only by Mg), and increase low-temperature toughness of the weld metal and a CTOD value thereof. However, when a total content of one kind or two kinds of Na and K in terms of Na and K in the fluorine compound is less than 0.05%, these effects cannot be obtained sufficiently, and the low-temperature toughness of the weld metal and the CTOD value thereof are reduced. On the other, when the total content of one kind or two kinds of Na and K in terms of Na and K in the fluorine compound is more than 0.3%, an arc is rough, and the amount of spatter occurring is large. Therefore, the total content of one kind or two kinds of Na and K in terms of Na and K in the fluorine compound is set to be from 0.05 to 0.3%. Na and K in the fluorine compound can be added from NaF, K₂SiF₆, Na₃AlF₆, or the like. The content in terms of Na or K is a total content of Na or K included therein.

[Total Content of One Kind or Two Kinds of Na₂O and K₂O in Flux: 0.05 to 0.2%]

Na₂O and K₂O act as an arc stabilizer and a slag forming agent. When a total content of one kind or two kinds of Na₂O and K₂O is less than 0.05%, an arc is unstable, and the amount of spatter occurring is large. In addition, a bead appearance is poor. On the other, when the total content of one kind or two kinds of Na₂O and K₂O is more than 0.2%, slag removability is poor. In addition, a metal easily drips in vertical upward welding. Therefore, the total content of one kind or two kinds of Na₂O and K₂O is set to be from 0.05 to 0.2%. Na₂O and K₂O can be added from a solid component of water glass including sodium silicate and potassium silicate, potassium titanate, sodium titanate, or the like.

[Total Content of Zr Oxide in Terms of ZrO₂ in Flux: 0.2% or Less]

A Zr oxide is added from zircon sand or a zirconium oxide. In addition, a small amount of the Zr oxide is included in a Ti oxide. However, when the total content of the Zr oxide in terms of ZrO₂ is more than 0.2%, slag removability is significantly poor. Therefore, the total content of the Zr oxide in terms of ZrO₂ is set to be 0.2% or less.

[No Seam in Steel Outer Skin]

The flux-cored wire for carbon dioxide gas shielded arc welding according to an embodiment of the present invention has a structure obtained by molding a steel outer skin into a pipe-like shape and filling a flux thereinto. The kind of the wire is roughly classified into a wire having no seam in a molded steel outer skin obtained by welding a joint of the steel outer skin, and a wire having a seam in a steel outer skin without welding a joint of the steel outer skin. In an embodiment of the present invention, a wire having any cross sectional structure can be employed. However, a wire having no seam in a steel outer skin is more preferable because the wire having no seam in the steel outer skin can be subjected to a heat treatment for reducing the total amount of hydrogen in the wire, a flux after manufacturing does not absorb moisture, and therefore it is possible to reduce the amount of diffusion hydrogen in a weld metal and to improve low-temperature cracking resistance.

The balance of the flux-cored wire for carbon dioxide gas shielded arc welding according to an embodiment of the present invention is Fe in the steel outer skin, iron powder added for adjusting components, a Fe component of iron alloy powder such as a Fe—Mn alloy, a Fe—Si alloy, a Fe—Si—Mn alloy, a Fe—Si—Cu alloy, a Fe—Ni alloy, Fe—B alloy, or a Fe—Mn—B alloy, and inevitable impurities. A flux filling ratio is not particularly limited, but is preferably from 8 to 20% with respect to the total mass of the wire from a viewpoint of productivity.

### Examples

Hereinafter, effects of an embodiment of the present invention will be described specifically with Examples.

By using SPCC defined in JIS G 3141 for a steel outer skin, the steel outer skin was molded into a U shape in a step of molding the steel outer skin. A flux which was dried to remove water sufficiently was filled into the steel outer skin. Thereafter, a wire having no seam obtained by welding a joint of the steel outer skin and a wire having a gap without welding were formed into pipes and were stretched to experimentally manufacture flux-cored wires containing various components, indicated in Tables 1 to 4. Each of the wires had a diameter of 1.2 mm. A flux filling ratio was from 10 to 18%.

TABLE 1

| | | wire component (% by mass) | | | | | | | | | | | | |
|---|---|---|---|---|---|---|---|---|---|---|---|---|---|---|
| | | | | | | | | | | in flux | | | | |
| | wire | total in steel outer skin and flux | | | | | | | | in terms | in terms | in terms | | *in |
| category | symbol | C | Si | Mn | Cu | Ni | Ti | B | Al | of TiO₂ | of SiO₂ | of Al₂O₃ | Mg | terms of F |
| Examples of | W1 | 0.05 | 0.22 | 1.23 | 0.41 | 0.37 | 0.34 | 0.016 | 0.02 | 4.03 | 0.34 | 0.14 | 0.23 | 0.27 |
| the present | W2 | 0.04 | 0.34 | 2.24 | 0.23 | 0.54 | 0.58 | 0.011 | 0.01 | 5.16 | 0.12 | 0.08 | 0.64 | 0.16 |
| invention | W3 | 0.07 | 0.57 | 2.77 | 0.14 | 0.25 | 0.49 | 0.017 | 0.01 | 6.28 | 0.52 | 0.02 | 0.38 | 0.09 |
| | W4 | 0.07 | 0.56 | 2.57 | 0.08 | 0.59 | 0.13 | 0.009 | 0.02 | 7.65 | 0.21 | 0.16 | 0.13 | 0.21 |
| | W5 | 0.04 | 0.41 | 1.71 | 0.49 | 0.33 | 0.25 | 0.014 | 0.02 | 7.97 | 0.37 | 0.23 | 0.45 | 0.05 |
| | W6 | 0.05 | 0.28 | 1.55 | 0.36 | 0.47 | 0.47 | 0.017 | 0.05 | 4.63 | 0.57 | 0.17 | 0.62 | 0.16 |
| | W7 | 0.04 | 0.44 | 1.93 | 0.02 | 0.36 | 0.31 | 0.007 | 0.04 | 5.41 | 0.31 | 0.28 | 0.56 | 0.17 |
| | W8 | 0.06 | 0.52 | 2.11 | 0.28 | 0.62 | 0.46 | 0.013 | 0.03 | 4.23 | 0.18 | 0.07 | 0.79 | 0.23 |
| | W9 | 0.05 | 0.32 | 1.35 | 0.15 | 0.45 | 0.19 | 0.015 | 0.04 | 6.38 | 0.54 | 0.13 | 0.72 | 0.19 |
| | W10 | 0.04 | 0.42 | 2.37 | 0.30 | 0.32 | 0.63 | 0.008 | 0.02 | 5.71 | 0.36 | 0.25 | 0.32 | 0.28 |
| | W11 | 0.03 | 0.57 | 2.64 | 0.33 | 0.21 | 0.42 | 0.015 | 0.01 | 4.76 | 0.23 | 0.21 | 0.64 | 0.24 |
| | W12 | 0.08 | 0.25 | 1.87 | 0.17 | 0.68 | 0.21 | 0.011 | 0.01 | 7.64 | 0.49 | 0.15 | 0.73 | 0.27 |
| | W13 | 0.05 | 0.33 | 2.04 | 0.43 | 0.52 | 0.56 | 0.016 | 0.03 | 5.68 | 0.34 | 0.09 | 0.54 | 0.08 |
| | W14 | 0.07 | 0.47 | 1.31 | 0.36 | 0.29 | 0.38 | 0.019 | 0.02 | 6.57 | 0.17 | 0.18 | 0.23 | 0.16 |
| | W15 | 0.06 | 0.51 | 2.37 | 0.13 | 0.55 | 0.22 | 0.005 | 0.04 | 7.11 | 0.55 | 0.27 | 0.24 | 0.14 |

*As the fluorine compound, one or more kinds of CaF₂, AlF₃, NaF, K₂SiF₆, K₂ZrF₆, and Na₃AlF₆ were used.

TABLE 2

| | | wire component (% by mass) | | | | | | | | |
|---|---|---|---|---|---|---|---|---|---|---|
| | | in flux | | | | | | | | |
| | | | | | | | total | | | |
| | | **in fluorine compound | | | | | content of | | | |
| | wire | in terms of | | total content in terms of | | | Na₂O and | in terms | | |
| category | symbol | Na | in terms of K | Na and K | Na₂O | K₂O | K₂O | of ZrO₂ | ***others | wire seam |
| Examples of | W1 | 0.05 | 0.11 | 0.16 | 0.07 | 0.05 | 0.12 | 0.12 | balance | seamless |
| the present | W2 | 0.11 | 0.03 | 0.14 | 0.11 | 0.05 | 0.16 | 0.08 | balance | seamless |
| invention | W3 | 0.09 | 0.07 | 0.16 | 0.07 | 0.04 | 0.11 | 0.05 | balance | seamless |
| | W4 | 0.13 | 0.12 | 0.25 | 0.08 | — | 0.08 | 0.16 | balance | seamless |
| | W5 | 0.09 | — | 0.09 | 0.09 | 0.06 | 0.15 | 0.11 | balance | seamless |
| | W6 | 0.11 | 0.11 | 0.22 | — | 0.12 | 0.12 | 0.03 | balance | seamed |
| | W7 | 0.12 | 0.05 | 0.17 | 0.07 | 0.06 | 0.13 | 0.14 | balance | seamless |
| | W8 | 0.05 | — | 0.05 | 0.13 | — | 0.13 | 0.18 | balance | seamless |
| | W9 | 0.07 | 0.05 | 0.12 | 0.11 | 0.06 | 0.17 | 0.11 | balance | seamed |
| | W10 | 0.15 | 0.13 | 0.28 | 0.05 | 0.03 | 0.08 | 0.09 | balance | seamless |
| | W11 | 0.08 | 0.05 | 0.13 | 0.08 | 0.05 | 0.13 | 0.17 | balance | seamless |
| | W12 | — | 0.11 | 0.11 | — | 0.09 | 0.09 | 0.003 | balance | seamless |
| | W13 | 0.06 | 0.13 | 0.19 | 0.07 | 0.05 | 0.12 | 0.13 | balance | seamless |
| | W14 | — | 0.15 | 0.15 | 0.05 | — | 0.05 | 0.005 | balance | seamed |
| | W15 | 0.11 | 0.07 | 0.18 | 0.11 | 0.08 | 0.19 | 0.17 | balance | seamless |

**As Na and K in fluorine compound, one or more kinds of NaF, K₂SiF₆, K₂ZrF₆, and Na₃AlF₆ were used.
***Others were Fe in steel outer skin, iron powder, a Fe component of iron alloy powder, and inevitable impurities.

TABLE 3

| | | wire component (% by mass) | | | | | | | | | | | | |
|---|---|---|---|---|---|---|---|---|---|---|---|---|---|---|
| | | | | | | | | | | in flux | | | | |
| | wire | total in steel outer skin and flux | | | | | | | | in terms | in terms | in terms of | | *in terms |
| category | symbol | C | Si | Mn | Cu | Ni | Ti | B | Al | of TiO₂ | of SiO₂ | Al₂O₃ | Mg | of F |
| Comparative | W16 | 0.02 | 0.45 | 1.56 | 0.35 | 0.45 | 0.33 | 0.011 | 0.03 | 3.93 | 0.22 | 0.15 | 0.51 | 0.18 |
| Examples | W17 | 0.10 | 0.37 | 2.41 | 0.18 | 0.68 | 0.41 | 0.015 | 0.02 | 4.23 | 0.04 | 0.27 | 0.34 | 0.23 |
| | W18 | 0.05 | 0.14 | 2.59 | 0.08 | 0.51 | 0.17 | 0.008 | 0.02 | 6.47 | 0.41 | 0.21 | 0.03 | 0.09 |
| | W19 | 0.04 | 0.67 | 2.26 | 0.42 | 0.42 | 0.26 | 0.018 | 0.01 | 4.38 | 0.36 | 0.01 | 0.76 | 0.15 |
| | W20 | 0.07 | 0.56 | 1.14 | 0.29 | 0.25 | 0.53 | 0.014 | 0.03 | 4.55 | 0.22 | 0.09 | 0.85 | 0.13 |
| | W21 | 0.06 | 0.31 | 2.85 | 0.36 | 0.46 | 0.34 | 0.009 | 0.04 | 7.19 | 0.54 | 0.14 | 0.58 | 0.37 |
| | W22 | 0.05 | 0.27 | 1.43 | 0.003 | 0.41 | 0.36 | 0.011 | 0.03 | 5.54 | 0.32 | 0.16 | 0.27 | 0.23 |
| | W23 | 0.04 | 0.53 | 2.73 | 0.56 | 0.54 | 0.52 | 0.016 | 0.04 | 4.31 | 0.37 | 0.21 | 0.18 | 0.03 |
| | W24 | 0.04 | 0.48 | 1.86 | 0.31 | 0.14 | 0.28 | 0.015 | 0.04 | 6.13 | 0.24 | 0.14 | 0.32 | 0.26 |
| | W25 | 0.03 | 0.39 | 2.61 | 0.22 | 0.77 | 0.15 | 0.003 | 0.03 | 7.76 | 0.43 | 0.13 | 0.45 | 0.18 |
| | W26 | 0.07 | 0.44 | 1.70 | 0.14 | 0.21 | 0.04 | 0.018 | 0.05 | 5.57 | 0.19 | 0.17 | 0.61 | 0.14 |
| | W27 | 0.06 | 0.51 | 2.51 | 0.35 | 0.42 | 0.67 | 0.007 | 0.02 | 4.36 | 0.27 | 0.23 | 0.78 | 0.28 |
| | W28 | 0.07 | 0.34 | 2.11 | 0.17 | 0.51 | 0.31 | 0.025 | 0.04 | 6.47 | 0.39 | 0.25 | 0.37 | 0.11 |
| | W29 | 0.05 | 0.49 | 1.64 | 0.45 | 0.56 | 0.25 | 0.016 | 0.06 | 5.06 | 0.56 | 0.16 | 0.43 | 0.07 |
| | W30 | 0.04 | 0.55 | 1.43 | 0.23 | 0.44 | 0.53 | 0.013 | 0.05 | 8.08 | 0.31 | 0.06 | 0.63 | 0.23 |
| | W31 | 0.03 | 0.32 | 1.87 | 0.41 | 0.62 | 0.17 | 0.015 | 0.04 | 7.33 | 0.47 | 0.37 | 0.54 | 0.21 |
| | W32 | 0.04 | 0.29 | 2.14 | 0.25 | 0.39 | 0.58 | 0.007 | 0.03 | 4.98 | 0.68 | 0.05 | 0.71 | 0.27 |

*As the fluorine compound, one or more kinds of CaF₂, AlF₃, NaF, K₂SiF₆, K₂ZrF₆, and Na₃AlF₆ were used.

TABLE 4

| | | wire component (% by mass) | | | | | | | | |
|---|---|---|---|---|---|---|---|---|---|---|
| | | in flux | | | | | | | | |
| | | **in fluorine compound | | | | | total content | | | |
| | wire | | | total content in | | | of Na₂O and | in terms | | |
| category | symbol | in terms of Na | in terms of K | terms of Na and K | Na₂O | K₂O | K₂O | of ZrO₂ | ***others | wire seam |
| Comparative | W16 | 0.03 | — | 0.03 | 0.06 | 0.05 | 0.11 | 0.06 | balance | seamless |
| Examples | W17 | 0.11 | 0.05 | 0.16 | 0.11 | 0.05 | 0.16 | 0.11 | balance | seamed |
| | W18 | 0.07 | 0.05 | 0.12 | 0.07 | — | 0.07 | 0.05 | balance | seamless |
| | W19 | 0.16 | 0.11 | 0.27 | 0.09 | 0.05 | 0.14 | 0.27 | balance | seamless |
| | W20 | 0.08 | — | 0.08 | 0.15 | 0.12 | 0.27 | 0.13 | balance | seamless |
| | W21 | 0.12 | 0.07 | 0.19 | — | 0.07 | 0.07 | 0.05 | balance | seamed |
| | W22 | — | 0.11 | 0.11 | 0.03 | — | 0.03 | 0.03 | balance | seamless |
| | W23 | 0.03 | 0.03 | 0.06 | 0.08 | 0.05 | 0.13 | 0.07 | balance | seamed |
| | W24 | 0.22 | 0.14 | 0.36 | 0.06 | 0.03 | 0.09 | 0.16 | balance | seamless |
| | W25 | 0.09 | 0.06 | 0.15 | 0.11 | 0.04 | 0.15 | 0.05 | balance | seamless |
| | W26 | — | 0.07 | 0.07 | 0.09 | 0.03 | 0.12 | 0.11 | balance | seamless |
| | W27 | 0.14 | 0.08 | 0.22 | 0.11 | 0.05 | 0.16 | 0.03 | balance | seamless |
| | W28 | 0.11 | 0.04 | 0.15 | 0.13 | 0.04 | 0.17 | 0.02 | balance | seamless |
| | W29 | 0.16 | 0.12 | 0.28 | 0.08 | 0.04 | 0.12 | 0.17 | balance | seamless |
| | W30 | 0.08 | 0.06 | 0.14 | 0.06 | 0.02 | 0.08 | 0.06 | balance | seamless |
| | W31 | 0.06 | 0.03 | 0.09 | — | 0.06 | 0.06 | 0.03 | balance | seamless |
| | W32 | 0.05 | 0.03 | 0.08 | 0.09 | 0.06 | 0.15 | 0.11 | balance | seamless |

**As Na and K in fluorine compound, one or more kinds of NaF, K₂SiF₆, K₂ZrF₆, and Na₃AlF₆ were used.
***Others were Fe in steel outer skin, iron powder, a Fe component of iron alloy powder, and inevitable impurities.

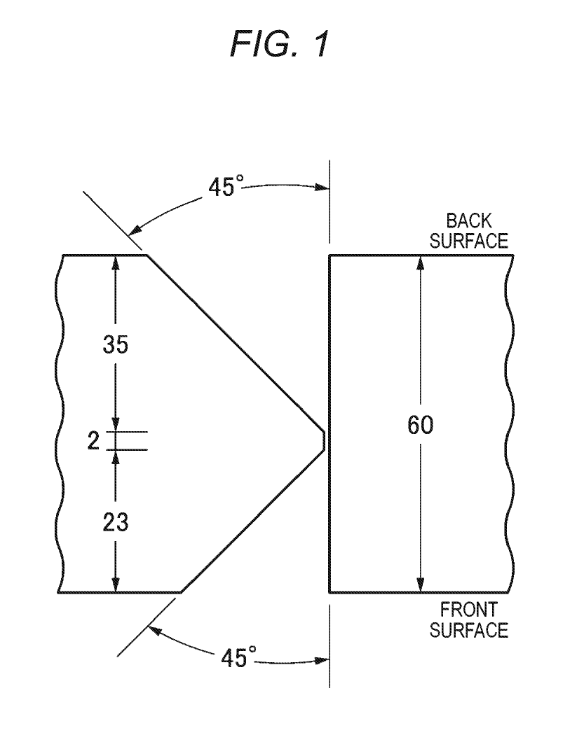

For the experimentally manufactured wires, welding weldability was evaluated by vertical upward fillet welding using a steel plate defined by JIS Z G 3126 SLA 365, and mechanical properties were evaluated by a weld cracking test and a deposited metal test. In addition, for some experimentally manufactured wires, a welded joint test was performed by vertical upward welding using a K groove illustrated in FIG. 1 to perform a CTOD test. In this K groove, a groove angle was set to 45°, a groove depth on a surface side was set to 23 mm, and a groove depth on a back side was set to 35 mm. These welding conditions are indicated in Table 5.

TABLE 5

| | | plate | | | | | | welding |
|---|---|---|---|---|---|---|---|---|
| | welding | thickness | | shielding | | | | speed |
| test item | position | (mm) | welding method | gas | groove | current (A) | voltage (V) | (cm/min) |
| evaluation of welding | vertical | 12 | semiautomatic | 100% | T type fillet | 210 | 23 | about 10 |
| weldability | upward | | MAG | CO₂ 25 L/min | | | | |
| deposited metal test | flat | 20 | automatic MAG | | in conformity with JIS Z | 270 | 29 | 30 |
| | | | | | 3111 | | | |
| weld cracking test | flat | 40 | automatic MAG | | 20° U groove on one | 240 | 26 | 22 |
| | | | | | side | | | |
| welded joint test (CTOD) | vertical | 50 | semiautomatic | | K groove (FIG. 1) | 190 to 220 | 21 to 25 | 19 to 23 |
| | upward | | MAG | | | | | |

Evaluation of welding weldability by vertical upward welding was performed by examining stability of an arc when semi-automatic MAG welding was performed, a occurring state of spatters, presence of melted metal dripping, a bead appearance/shape, slag removability, and presence of high-temperature cracking.

The weld cracking test was performed in conformity with a U shape weld cracking test method (JIS Z 3157) at a preheated temperature of a test body of 75° C. Presence of surface cracking or cross section cracking (five cross sections) of the test body 58 hours after welding was examined by penetrant testing (JIS Z 2343).

The deposited metal test was performed by welding in conformity with JIS Z 3111. A tensile test piece (No. AO) and an impact test piece (V notch test piece) were collected from a central part of a deposited metal in a plate thickness direction to perform a mechanical test. Evaluation of toughness was performed by a Charpy impact test at −40° C. Each test piece was subjected to a Charpy impact test repeatedly, and a test piece having an average of three absorption energies of 60 J or more was evaluated as being excellent. In evaluation of tensile strength, a test piece having tensile strength of 490 to 670 MPa was evaluated as being excellent.

In the welded joint test, a back side of the K groove illustrated in FIG. 1 was welded, and then the groove was subjected to back chipping of a radius of 6 mm and a groove angle of 45° from a steel plate surface to a depth of 34 mm, and a surface side was welded. For evaluation of a CTOD value by the welded joint test, a CTOD test piece was collected in conformity with BS (British standard) 7448, and three tests were performed repeatedly at a test temperature of −10° C. A test piece having a minimum CTOD value of 0.5 mm or more was evaluated as being excellent. These results are indicated in Table 6 collectively.

TABLE 6

| | | | result of U | | | | |
|---|---|---|---|---|---|---|---|
| | | | shape | | | | |
| | | | cracking | result of mechanical test | | | |
| | | | test | | | CTOD | |
| | | examination result of | presence | | | value | total |
| category | wire symbol | welding weldability | of cracking | TS (MPa) | vE−40 (J) | −10° C. (mm) | evaluation |
| Examples of | W1 | excellent | not | 497 | 102 | 0.78 | ◯ |
| the present | | | observed | | | | |
| invention | W2 | excellent | not | 606 | 78 | 0.63 | ◯ |
| | | | observed | | | | |
| | W3 | excellent | not | 668 | 68 | 0.61 | ◯ |
| | | | observed | | | | |
| | W4 | excellent | not | 653 | 73 | 0.63 | ◯ |
| | | | observed | | | | |
| | W5 | excellent | not | 541 | 90 | — | ◯ |
| | | | observed | | | | |
| | W6 | excellent | not | 524 | 93 | 0.68 | ◯ |
| | | | observed | | | | |
| | W7 | excellent | not | 555 | 86 | — | ◯ |
| | | | observed | | | | |
| | W8 | excellent | not | 610 | 76 | 0.61 | ◯ |
| | | | observed | | | | |
| | W9 | excellent | not | 516 | 96 | — | ◯ |
| | | | observed | | | | |
| | W10 | excellent | not | 603 | 88 | — | ◯ |
| | | | observed | | | | |
| | W11 | excellent | not | 630 | 73 | 0.65 | ◯ |
| | | | observed | | | | |
| | W12 | excellent | not | 576 | 84 | — | ◯ |
| | | | observed | | | | |
| | W13 | excellent | not | 575 | 83 | 0.66 | ◯ |
| | | | observed | | | | |
| | W14 | excellent | not | 545 | 91 | 0.69 | ◯ |
| | | | observed | | | | |
| | W15 | excellent | not | 624 | 74 | 0.60 | ◯ |
| | | | observed | | | | |
| Comparative | W16 | unstable arc, a large | not | 484 | 55 | 0.42 | X |
| Examples | | amount of spatter, | observed | | | | |
| | | metal dripping, poor | | | | | |
| | | bead | | | | | |
| | | appearance/shape | | | | | |
| | W17 | poor slag | observed | 680 | 50 | — | X |
| | | encapsulation, poor | | | | | |
| | | bead appearance | | | | | |
| | W18 | poor bead | not | 664 | 59 | 0.44 | X |
| | | appearance/shape | observed | | | | |
| | W19 | metal dripping, poor | not | 622 | 57 | — | X |
| | | slag removability | observed | | | | |
| | W20 | unstable arc, a large | not | 478 | 56 | 0.43 | X |
| | | amount of spatter, poor | observed | | | | |
| | | slag removability, | | | | | |
| | | metal dripping | | | | | |
| | W21 | unstable arc, a large | observed | 719 | 38 | 0.22 | X |
| | | amount of spatter, | | | | | |
| | | metal dripping | | | | | |
| | W22 | unstable arc, a large | not | 488 | 56 | — | X |
| | | amount of spatter, poor | observed | | | | |
| | | bead appearance | | | | | |
| | W23 | unstable arc | observed | 686 | 47 | — | X |
| | W24 | unstable arc, a large | not | 553 | 55 | 0.35 | X |
| | | amount of spatter | observed | | | | |
| | W25 | excellent | not | 676 | 53 | 0.44 | X |
| | | | observed | | | | |
| | W26 | excellent | not | 558 | 54 | 0.33 | X |
| | | | observed | | | | |
| | W27 | excellent | not | 654 | 43 | 0.41 | X |
| | | | observed | | | | |
| | W28 | crater cracking | not | 613 | 47 | 0.25 | X |
| | | | observed | | | | |
| | W29 | excellent | not | 538 | 39 | — | X |
| | | | observed | | | | |
| | W30 | excellent | not | 537 | 45 | — | X |
| | | | observed | | | | |
| | W31 | excellent | not | 563 | 42 | — | X |
| | | | observed | | | | |
| | W32 | excellent | not | 573 | 48 | — | X |
| | | | observed | | | | |

Wire symbols W1 to W15 in Tables 1, 2, and 6 represent Examples of the present invention, and wire symbols W16 to W32 in Tables 3, 4, and 6 represent Comparative Examples. The wire symbols W1 to W15 as Examples of the present invention had compositions of components within a range defined in an embodiment of the present invention. Therefore, the wire symbols W1 to W15 had excellent welding weldability, no crack in the U type cracking test, excellent tensile strength of a deposited metal, and an excellent absorption energy thereof. That is, the wire symbols W1 to W15 obtained extremely satisfactory results. The wire symbols W1 to W4, W6, W8, W11, W13, W14, and W15 which had been subjected to the welded joint test obtained excellent CTOD values.

The wire symbols W6, W9, and W14 had a seam in a steel outer skin, but had proper tensile strength of a weld metal and a proper absorption energy thereof, and therefore caused no crack in a weld in the U type cracking test.

The wire symbol W16 in Comparative Examples included a small amount of C, and therefore had low tensile strength of a deposited metal. In addition, the wire symbol W16 included a small amount of a Ti oxide in terms of TiO₂. Therefore, an arc was unstable, the amount of spatter occurring was large, a bead appearance/shape was poor, and metal dripping occurred. In addition, the wire symbol W16 included a small amount of Na and K in terms of Na and K in a fluorine compound. Therefore, the absorption energy of the deposited metal was low and a CTOD value thereof in the welded joint test was low.

The wire symbol W17 included a large amount of C, and therefore had high tensile strength of a deposited metal and a low absorption energy thereof. In addition, the wire symbol W17 included a small amount of a Si oxide in terms of SiO₂. Therefore, a slag encapsulation was poor and a bead appearance was poor. The wire symbol W17 had a seam in a steel outer skin and had high tensile strength of the deposited metal. Therefore, a crack was occurred in a weld in the U type cracking test.

The wire symbol W18 included a small amount of Si, and therefore had a poor bead appearance/shape. In addition, the wire symbol W18 included a small amount of Mg, and therefore had a low absorption energy of a deposited metal and a low CTOD value thereof in the welded joint test.

The wire symbol W19 included a large amount of Si, and therefore had a low absorption energy of a deposited metal. In addition, the wire symbol W19 included a small amount in terms of Al₂O₃. Therefore, metal dripping occurred. In addition, the wire symbol W19 included a large amount of a Zr oxide in terms of ZrO₂, and therefore had a poor slag removability.

The wire symbol W20 included a small amount of Mn, and therefore had low tensile strength of a deposited metal and a low absorption energy thereof. In addition, a CTOD value thereof in the welded joint test was low. In addition, the wire symbol W20 had a large amount of Mg. Therefore, an arc was unstable, and the amount of spatter occurring was large. In addition, the wire symbol W20 included a large amount of Na₂O and K₂O in total. Therefore, a slag removability was poor and metal dripping occurred.

The wire symbol W21 included a large amount of Mn, and therefore had high tensile strength of a deposited metal, a low absorption energy thereof, and a low CTOD value thereof in the welded joint test. In addition, the wire symbol W21 included a large amount of a fluorine compound in terms of F. Therefore, an arc was unstable, the amount of spatter occurring was large, and metal dripping occurred. In addition, the wire symbol W21 had a seam in a steel outer skin and had high tensile strength of the deposited metal. Therefore, a crack was occurred in a weld in the U type cracking test.

The wire symbol W22 included a small amount of Cu, and therefore had low tensile strength of a deposited metal and a low absorption energy thereof. In addition, the wire symbol W22 included a small amount of Na₂O and K₂O in total. Therefore, an arc was unstable, the amount of spatter occurring was large, and a bead appearance was poor.

The wire symbol W23 included a large amount of Cu, and therefore had high tensile strength of a deposited metal and a low absorption energy thereof. In addition, the wire symbol W23 included a small amount of a fluorine compound in terms of F. Therefore, an arc was unstable. In addition, the wire symbol W23 had a seam in a steel outer skin and had high tensile strength of the deposited metal. Therefore, a crack was occurred in a weld in the U type cracking test.

The wire symbol W24 included a small amount of Ni, and therefore had a low absorption energy of a deposited metal and a low CTOD value thereof in the welded joint test. In addition, the total content of Na and Kin terms of Na and Kin a fluorine compound was large. Therefore, an arc was unstable, and the amount of spatter occurring was large.

The wire symbol W25 included a large amount of Ni, and therefore had high tensile strength of a deposited metal. In addition, the wire symbol W25 included a small amount of B, and therefore had a low absorption energy of the deposited metal and a low CTOD value thereof in the welded joint test.

The wire symbol W26 included a small amount of Ti, and therefore had a low absorption energy of a deposited metal and a low CTOD value thereof in the welded joint test.

The wire symbol W27 included a large amount of Ti, and therefore had a low absorption energy of a deposited metal and a low CTOD value thereof in the welded joint test.

The wire symbol W28 included a large amount of B, and therefore had a low absorption energy of a deposited metal and a low CTOD value thereof in the welded joint test. High-temperature cracking occurred in a crater portion.

The wire symbol W29 included a large amount of Al, and therefore had a low absorption energy of a deposited metal.

The wire symbol W30 included a large amount of a Ti oxide in terms of TiO₂, and therefore had a low absorption energy of a deposited metal.

The wire symbol W31 included a large amount of an Al oxide in terms of Al₂O₃, and therefore had a low absorption energy of a deposited metal.

The wire symbol W32 included a large amount of a Si oxide in terms of SiO₂, and therefore had a low absorption energy of a deposited metal.

What is claimed is:

1. A flux-cored wire for carbon dioxide gas shielded arc welding obtained by filling a flux into a steel outer skin, comprising;
in terms of % by mass with respect to a total mass of the wire, as a total in the steel outer skin and the flux,
0.03 to 0.08% of C;
0.2 to 0.6% of Si;
1.2 to 2.8% of Mn;
0.01 to 0.5% of Cu;
0.2 to 0.7% of Ni;
0.1 to 0.6% of Ti;
0.005 to 0.020% of B; and
0.05% or less of Al, and
further comprising:
in terms of % by mass with respect to the total mass of the wire, in the flux,
4.0 to 8.0% of a Ti oxide in terms of TiO₂ in total;
0.1 to 0.6% of a Si oxide in terms of SiO₂ in total;
0.02 to 0.3% of an Al oxide in terms of Al₂O₃ in total;
0.1 to 0.8% of Mg;
0.05 to 0.3% of a fluorine compound in terms of F in total;
0.05 to 0.3% of one kind or two kinds of Na and K in the fluorine compound in terms of Na and K in total;
0.05 to 0.2% of one kind or two kinds of Na₂O and K₂O in total; and
0.2% or less of a Zr oxide in terms of ZrO₂ in total,
the balance being Fe in the steel outer skin, iron powder, a Fe component of iron alloy powder, and inevitable impurities.

2. The flux-cored wire for carbon dioxide gas shielded arc welding according to claim 1, wherein a seam in the molded steel outer skin is eliminated by welding a joint of the steel outer skin.
